(19) United States
(12) Patent Application Publication
(10) Pub. No.: US 2021/0166685 A1
(43) Pub. Date: Jun. 3, 2021

(54) SPEECH PROCESSING APPARATUS AND SPEECH PROCESSING METHOD

(71) Applicant: Sony Corporation, Tokyo (JP)

(72) Inventor: Chika Myoga, Tokyo (JP)

(73) Assignee: Sony Corporation, Tokyo (JP)

(21) Appl. No.: 17/046,747

(22) PCT Filed: Jan. 25, 2019
(86) PCT No.: PCT/JP2019/002542

§ 371 Date: Oct. 9, 2020

(30) Foreign Application Priority Data
Apr. 19, 2018 (JP) 2018-080816

(51) Int. Cl. G10L 15/22; G06K 9/00; G10L 15/18

(52) U.S. Cl. CPC G10L 15/22; G10L 2015/227; G10L 15/1822; G06K 9/00302

(57) ABSTRACT

[Problem] To obtain a meaning intended for conveyance by a user from speech of the user while reducing trouble for the user.

[Solution] A speech processing apparatus includes an analysis unit configured to analyze a meaning of speech uttered by a user based on a recognition result of the speech and an analysis result of a behavior of the user while the user is uttering the speech.

### FIELD

The present disclosure relates to a speech processing apparatus and a speech processing method.

### BACKGROUND

Speech processing apparatus with a speech agent function has recently become popular. The speech agent function is a function to analyze the meaning of speech uttered by a user and execute processing in accordance with the meaning obtained by the analysis. For example, when a user utters a speech “Send an email let's meet in Shibuya tomorrow to A”, the speech processing apparatus with the speech agent function analyzes the meaning of the speech, and sends an email having a body “Let's meet in Shibuya tomorrow” to A by using a pre-registered email address of A. Examples of other types of processing executed by the speech agent function include answering a question from a user, for example, as disclosed in Patent Literature 1.

### CITATION LIST

### Patent Literature

Patent Literature 1: JP 2016-192121 A

### SUMMARY

### Technical Problem

The speech uttered by a user may include a correct speech expressing a meaning intended for conveyance by the user, and an error speech not expressing the meaning intended for conveyance by the user. The error speech is, for example, a filler such as “well” and “umm”, and a soliloquy such as “what was it?”. When a user utters speech including the error speech, the user may utter the speech again from the start to provide the speech including only the correct speech to the speech agent function. However, uttering the speech again from the start is troublesome for the user.

Thus, the present disclosure proposes a novel and improved speech processing apparatus and method enabling acquisition of a meaning intended for conveyance by a user from speech of the user while reducing the trouble for the user.

### Solution to Problem

According to the present disclosure, a speech processing apparatus is provided that includes an analysis unit configured to analyze a meaning of speech uttered by a user based on a recognition result of the speech and an analysis result of a behavior of the user while the user is uttering the speech.

Moreover, according to the present disclosure, a speech processing method is provided that includes analyzing, by a processor, a meaning of speech uttered by a user based on a recognition result of the speech and an analysis result of a behavior of the user while the user is uttering the speech.

### Advantageous Effects of Invention

As described above, the present disclosure enables the acquisition of the meaning intended for conveyance by the user from the speech of the user while reducing the trouble for the user. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an overview of a speech processing apparatus 20 according to an embodiment of the present disclosure.

FIG. 2 is an explanatory diagram illustrating a configuration of the speech processing apparatus 20 according to the embodiment of the present disclosure.

FIG. 3 is an explanatory diagram illustrating a first example of meaning correction.

FIG. 4 is an explanatory diagram illustrating a second example of the meaning correction.

FIG. 5 is an explanatory diagram illustrating a third example of the meaning correction.

FIG. 6 is an explanatory diagram illustrating a fourth example of the meaning correction.

FIG. 7 is a flowchart illustrating an operation of the speech processing apparatus 20 according to the embodiment of the present disclosure.

FIG. 8 is an explanatory diagram illustrating a hardware configuration of the speech processing apparatus 20.

### DESCRIPTION OF EMBODIMENTS

Hereinafter, preferred embodiments of the present disclosure will be described in detail with reference to the appended drawings. In this specification and the appended drawings, structural elements having substantially the same function and structure are denoted with the same reference numerals, and repeated explanation of these structural elements is omitted.

Additionally, in this specification and the appended drawings, a plurality of structural elements having substantially the same function and structure are sometimes distinguished from each other using different alphabets after the same reference numerals. However, when a plurality of structural elements having substantially the same function and structure do not particularly have to be distinguished from each other, the structural elements are denoted only with the same reference numerals.

Moreover, the present disclosure will be described in the order of the following items.
1. Overview of Speech processing apparatus
2. Configuration of Speech processing apparatus
3. Specific examples of Meaning correction
   3-1. First example
   3-2. Second example
   3-3. Third example
   3-4. Fourth example
4. Operation of Speech processing apparatus
5. Modification
6. Hardware configuration
7. Conclusion

Overview of Speech Processing Apparatus

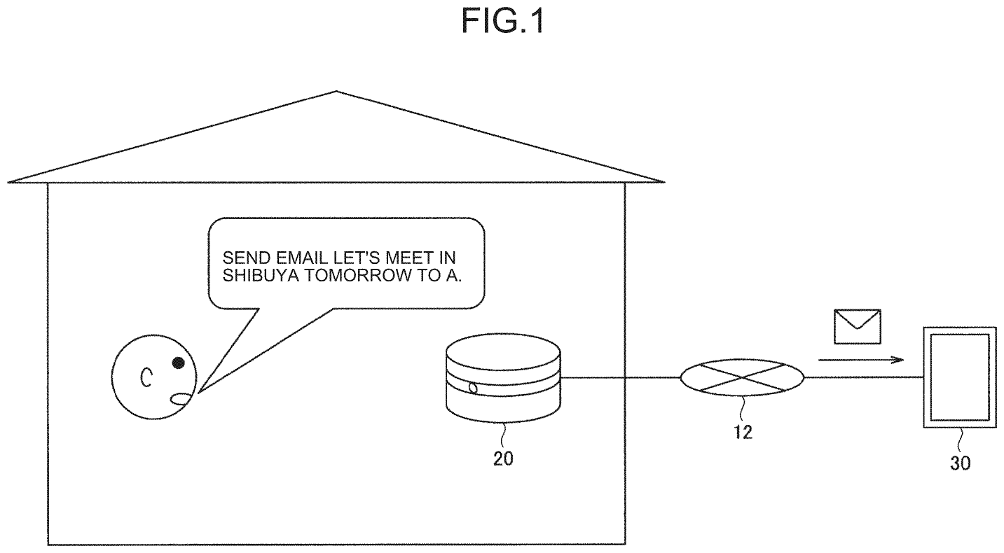

First, an overview of a speech processing apparatus according to an embodiment of the present disclosure will be described with reference to FIG. 1.

FIG. 1 is an explanatory diagram illustrating an overview of a speech processing apparatus 20 according to the embodiment of the present disclosure. As illustrated in FIG. 1, the speech processing apparatus 20 is placed in, for example, a house. The speech processing apparatus 20 has a speech agent function to analyze the meaning of speech uttered by a user of the speech processing apparatus 20, and execute processing in accordance with the meaning obtained by the analysis.

For example, when the user of the speech processing apparatus 20 utters a speech “Send an email let's meet in Shibuya tomorrow to A” as illustrated in FIG. 1, the speech processing apparatus 20 analyzes the meaning of the speech, and understands that the task is to send an email, the destination is A, and the body of the email is “let's meet in Shibuya tomorrow”. The speech processing apparatus 20 sends an email having a body “Let's meet in Shibuya tomorrow” to a mobile terminal 30 of A via a network 12 by using a pre-registered email address of A.

Note that the speech processing apparatus 20, which is illustrated as a stationary apparatus in FIG. 1, is not limited to the stationary apparatus. The speech processing apparatus 20 may be, for example, a portable information processing apparatus such as a smartphone, a mobile phone, a personal handy phone system (PHS), a portable music player, a portable video processing apparatus and a portable game console, or an autonomous mobile robot. Additionally, the network 12 is a wired or wireless transmission path for information to be transmitted from an apparatus connected to the network 12. Examples of the network 12 may include a public network such as Internet, a phone network and a satellite communication network, and various local area networks (LAN) and wide area networks (WAN) including Ethernet (registered trademark). The network 12 may also include a dedicated network such as an Internet protocol-virtual private network (IP-VPN).

Here, the speech uttered by the user may include a correct speech expressing a meaning intended for conveyance by the user, and an error speech not expressing the meaning intended for conveyance by the user. The error speech is, for example, a filler such as “well” and “umm”, and a soliloquy such as “what was it?” A negative word such as “not” and a speech talking to another person also sometimes fall under the error speech. When the user utters speech including such an error speech, e.g., when the user utters a speech “Send an email let's meet in, umm . . . where is that? Shibuya tomorrow to A”, uttering the speech again from the start is troublesome for the user.

The inventors of this application have developed the embodiment of the present disclosure by focusing on the above circumstances. In accordance with the embodiment of the present disclosure, the meaning intended for conveyance by the user can be obtained from the speech of the user while reducing the trouble for the user. In the following, a configuration and an operation of the speech processing apparatus 20 according to the embodiment of the present disclosure will be sequentially described in detail.

Configuration of Speech Processing Apparatus

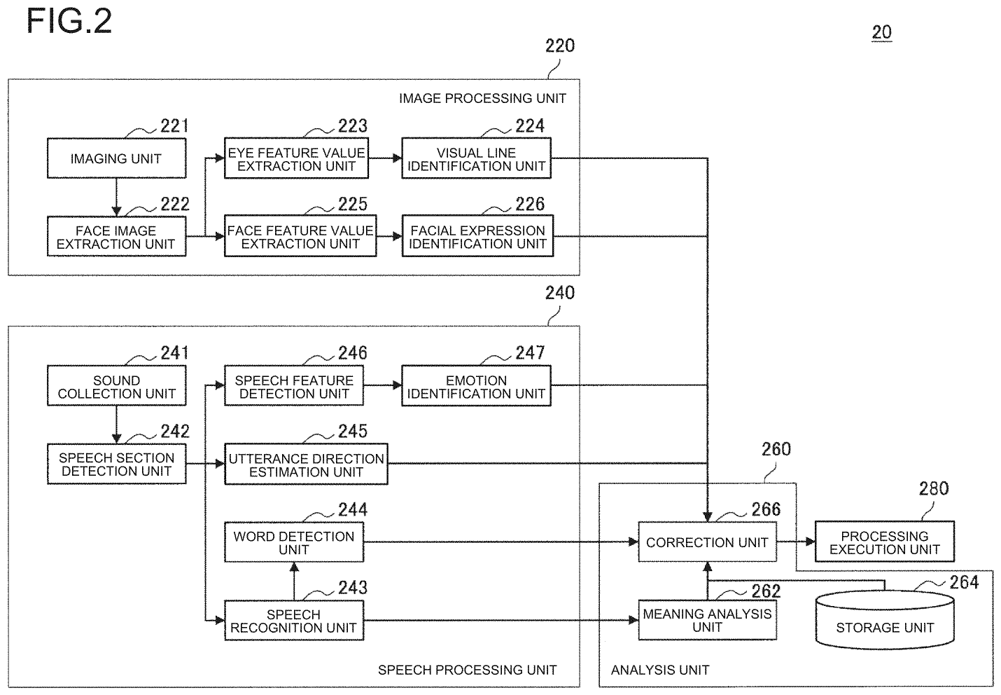

FIG. 2 is an explanatory diagram illustrating the configuration of the speech processing apparatus 20 according to the embodiment of the present disclosure. As illustrated in FIG. 2, the speech processing apparatus 20 includes an image processing unit 220, a speech processing unit 240, an analysis unit 260, and a processing execution unit 280.

(Image Processing Unit)

The image processing unit 220 includes an imaging unit 221, a face image extraction unit 222, an eye feature value extraction unit 223, a visual line identification unit 224, a face feature value extraction unit 225, and a facial expression identification unit 226 as illustrated in FIG. 2.

The imaging unit 221 captures an image of a subject to acquire the image of the subject. The imaging unit 221 outputs the acquired image of the subject to the face image extraction unit 222.

The face image extraction unit 222 determines whether a person area exists in the image input from the imaging unit 221. When the person area exists in the imaging unit 221, the face image extraction unit 222 extracts a face image in the person area to identify a user. The face image extracted by the face image extraction unit 222 is output to the eye feature value extraction unit 223 and the face feature value extraction unit 225.

The eye feature value extraction unit 223 analyzes the face image input from the face image extraction unit 222 to extract a feature value for identifying a visual line of the user.

The visual line identification unit 224, which is an example of a behavior analysis unit configured to analyze user behaviors, identifies a direction of the visual line based on the feature value extracted by the eye feature value extraction unit 223. The visual line identification unit 224 identifies a face direction in addition to the visual line direction. The visual line direction, a change in the visual line, and the face direction obtained by the visual line identification unit 224 are output to the analysis unit 260 as an example of analysis results of the user behaviors.

The face feature value extraction unit 225 extracts a feature value for identifying a facial expression of the user based on the face image input from the face image extraction unit 222.

The facial expression identification unit 226, which is an example of the behavior analysis unit configured to analyze the user behaviors, identifies the facial expression of the user based on the feature value extracted by the face feature value extraction unit 225. For example, the facial expression identification unit 226 may identify an emotion corresponding to the facial expression by recognizing whether the user changes his/her facial expression during utterance, and which emotion the change in the facial expression is based on, e.g., whether the user is angry, laughing, or embarrassed. A correspondence relation between the facial expression and the emotion may be explicitly given by a designer as a rule using a state of eyes or a mouth, or may be obtained by a method of preparing data in which the facial expression and the emotion are associated with each other and performing statistical learning using the data. Additionally, the facial expression identification unit 226 may identify the facial expression of the user by utilizing time series information based on a moving image, or by preparing a reference image (e.g., an image with a blank expression), and comparing the face image output from the face image extraction unit 222 with the reference image. The facial expression of the user and a change in the facial expression of the user identified by the facial expression identification unit 226 are output to the analysis unit 260 as an example of the analysis results of the user behaviors. Note that the speech processing apparatus 20 can also obtain whether the user is talking to another person or is uttering speech to the speech processing apparatus 20 by using the image obtained by the imaging unit 221 as the analysis results of the user behaviors.

(Speech Processing Unit)

The speech processing unit 240 includes a sound collection unit 241, a speech section detection unit 242, a speech recognition unit 243, a word detection unit 244, an utterance direction estimation unit 245, a speech feature detection unit 246, and an emotion identification unit 247 as illustrated in FIG. 2.

The sound collection unit 241 has a function as a speech input unit configured to acquire an electrical sound signal from air vibration containing environmental sound and speech. The sound collection unit 241 outputs the acquired sound signal to the speech section detection unit 242.

The speech section detection unit 242 analyzes the sound signal input from the sound collection unit 241, and detects a speech section equivalent to a speech signal in the sound signal by using an intensity (amplitude) of the sound signal and a feature value indicating a speech likelihood. The speech section detection unit 242 outputs the sound signal corresponding to the speech section, i.e., the speech signal to the speech recognition unit 243, the utterance direction estimation unit 245, and the speech feature detection unit 246. The speech section detection unit 242 may obtain a plurality of speech sections by dividing one utterance section by a break of the speech.

The speech recognition unit 243 recognizes the speech signal input from the speech section detection unit 242 to obtain a character string representing the speech uttered by the user. The character string obtained by the speech recognition unit 243 is output to the word detection unit 244 and the analysis unit 260.

The word detection unit 244 stores therein a list of words possibly falling under the error speech not expressing the meaning intended for conveyance by the user, and detects the stored word from the character string input from the speech recognition unit 243. The word detection unit 244 stores therein, for example, words falling under the filler such as “well” and “umm”, words falling under the soliloquy such as “what was it?” and words corresponding to the negative word such as “not” as the words possibly falling under the error speech. The word detection unit 244 outputs the detected word and an attribute (e.g., the filler or the negative word) of this word to the analysis unit 260.

The utterance direction estimation unit 245, which is an example of the behavior analysis unit configured to analyze the user behaviors, analyzes the speech signal input from the speech section detection unit 242 to estimate a user direction as viewed from the speech processing apparatus 20. When the sound collection unit 241 includes a plurality of sound collection elements, the utterance direction estimation unit 245 can estimate the user direction, which is a speech source direction, and movement of the user as viewed from the speech processing apparatus 20 based on a phase difference between speech signals obtained by the respective sound collection elements. The user direction and the user movement are output to the analysis unit 260 as an example of the analysis results of the user behaviors.

The speech feature detection unit 246 detects a speech feature such as a voice volume, a voice pitch and a pitch fluctuation from the speech signal input from the speech section detection unit 242. Note that the speech feature detection unit 246 can also calculate an utterance speed based on the character string obtained by the speech recognition unit 243 and the length of the speech section detected by the speech section detection unit 242.

The emotion identification unit 247, which is an example of the behavior analysis unit configured to analyze the user behaviors, identifies an emotion of the user based on the speech feature detected by the speech feature detection unit 246. For example, the emotion identification unit 247 acquires, based on the speech feature detected by the speech feature detection unit 246, information expressed in the voice depending on the emotion, e.g., an articulation degree such as whether the user speaks clearly or unclearly, a relative utterance speed in comparison with a normal utterance speed, and whether the user is angry or embarrassed. A correspondence relation between the speech and the emotion may be explicitly given by a designer as a rule using a voice state, or may be obtained by a method of preparing data in which the voice and the emotion are associated with each other and performing statistical learning using the data. Additionally, the facial expression identification unit 226 may identify the emotion of the user by preparing a reference voice of the user, and comparing the speech output from the speech section detection unit 242 with the reference voice. The user emotion and a change in the emotion identified by the emotion identification unit 247 are output to the analysis unit 260 as an example of the analysis results of the user behaviors.

(Analysis Unit)

The analysis unit 260 includes a meaning analysis unit 262, a storage unit 264, and a correction unit 266 as illustrated in FIG. 2.

The meaning analysis unit 262 analyzes the meaning of the character string input from the speech recognition unit 243. For example, when a character string “Send an email I won't need dinner tomorrow to Mom” is input, the meaning analysis unit 262 has a portion to perform morphological analysis on the character string and determine that the task is “to send an email” based on keywords such as “send” and “email”, and a portion to acquire the destination and the body as necessary arguments for achieving the task. In this example, “Mom” is acquired as the destination, and “I won't need dinner tomorrow” as the body. The meaning analysis unit 262 outputs these analysis results to the correction unit 266.

Note that a meaning analysis method may be any of a method of achieving the meaning analysis by machine learning using an utterance corpus created in advance, a method of achieving the meaning analysis by a rule, or a combination thereof. Additionally, to perform the morphological analysis as a part of the meaning analysis processing, the meaning analysis unit 262 has a mechanism of giving an attribute to each word, and an internal dictionary. The meaning analysis unit 262 can provide what kind of word the word included in the uttered speech is, that is, the attribute such as a person name, a place name and a common noun in accordance with the attribute giving mechanism and the dictionary.

The storage unit 264 stores therein a history of information regarding the user. The storage unit 264 may store therein information indicating, for example, what kind of order the user has given to the speech processing apparatus 20 by speech, and what kind of condition the image processing unit 220 and the speech processing unit 240 have identified regarding the user.

The correction unit 266 corrects the analysis results of the character string obtained by the meaning analysis unit 262. The correction unit 266 specifies a portion corresponding to the error speech included in the character string based on, for example, the change in the visual line of the user input from the visual line identification unit 224, the change in the facial expression of the user input from the facial expression identification unit 226, the word detection results input from the word detection unit 244, and the history of the information regarding the user stored in the storage unit 264, and corrects the portion corresponding to the error speech by deleting or replacing the portion. The correction unit 266 may specify the portion corresponding to the error speech in accordance with a rule in which a relation between each input and the error speech is described, or based on statistical learning of each input. The specification and correction processing of the portion corresponding to the error speech by the correction unit 266 will be more specifically described in “3. Specific examples of Meaning correction”.

(Processing Execution Unit)

The processing execution unit 280 executes processing in accordance with the meaning corrected by the correction unit 266. The processing execution unit 280 may be, for example, a communication unit that sends an email, a schedule management unit that inputs an appointment to a schedule, an answer processing unit that answers a question from the user, an appliance control unit that controls operations of household electrical appliances, or a display control unit that changes display contents in accordance with the meaning corrected by the correction unit 266.

### SPECIFIC EXAMPLES OF MEANING CORRECTION

The configuration of the speech processing apparatus 20 according to the embodiment of the present disclosure has been described above. Subsequently, some specific examples of the meaning correction performed by the facial expression identification unit 226 of the speech processing apparatus 20 will be sequentially described.

### First Example

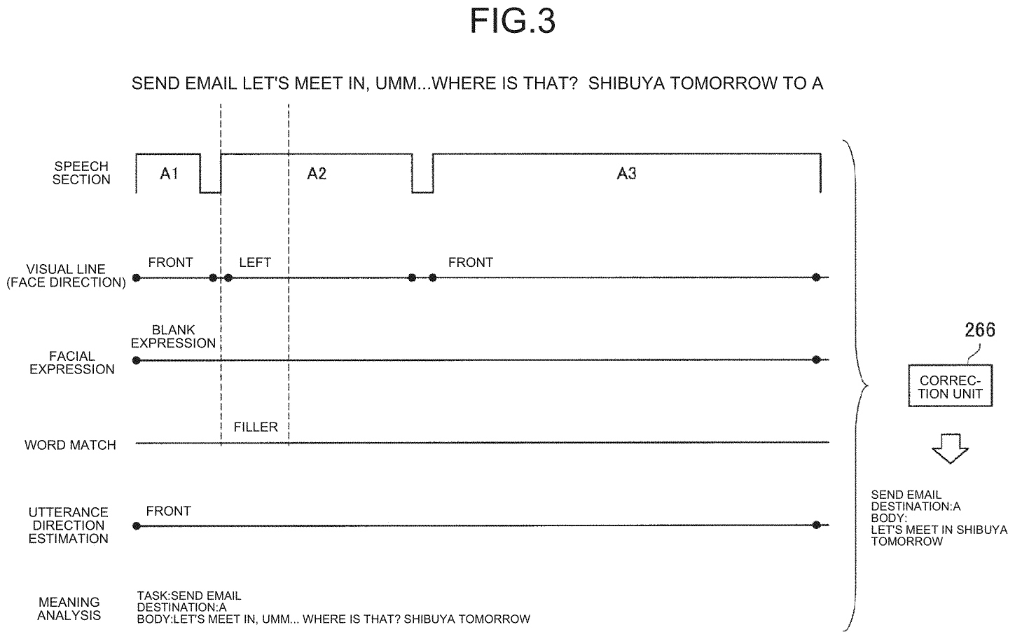

FIG. 3 is an explanatory diagram illustrating a first example of the meaning correction. FIG. 3 illustrates an example in which a user utters a speech “Send an email let's meet in, umm . . . where is that? Shibuya tomorrow to A”. In this example, the speech section detection unit 242 detects a speech section A1 corresponding to a speech “tomorrow”, a speech section A2 corresponding to a speech “umm . . . where is that?” and a speech section A3 corresponding to a speech “send an email let's meet in Shibuya to A” from one utterance section. The meaning analysis unit 262 analyzes the speech to acquire that the task is to send an email, the destination is A, and the body of the email is “let's meet in, umm . . . where is that? Shibuya tomorrow”.

Moreover, in the example of FIG. 3, the visual line identification unit 224 identifies that the visual line direction is front in the speech sections A1 and A3 and left in the speech section A2. The facial expression identification unit 226 identifies that the facial expression is a blank expression throughout the speech sections A1 to A3. The word detection unit 244 detects “umm” falling under the filler in the speech section A2. The utterance direction estimation unit 245 estimates that the utterance direction is front throughout the speech sections A1 to A3.

The correction unit 266 specifies whether each speech portion uttered by the user corresponds to the correct speech or the error speech based on the analysis results of the user behaviors such as the visual line direction, the facial expression and the utterance direction, and the detection of the filler. In the example illustrated in FIG. 3, the correction unit 266 specifies the speech portion corresponding to the speech section A2 as the error speech (a soliloquy or talking to another person) based on the facts that the filler is detected in the speech section A2, the visual line is directed to another direction in the speech section A2, and the speech section A2 is determined as a portion representing the email body.

As a result, the correction unit 266 deletes the meaning of the portion corresponding to the speech section A2 from the meaning of the uttered speech acquired by the meaning analysis unit 262. That is, the correction unit 266 corrects the meaning of the email body from “let's meet in, umm . . . where is that? Shibuya tomorrow” to “let's meet in Shibuya tomorrow”. With such a configuration, the processing execution unit 280 sends an email having a body “Let's meet in Shibuya tomorrow” intended for conveyance by the user to A.

### Second Example

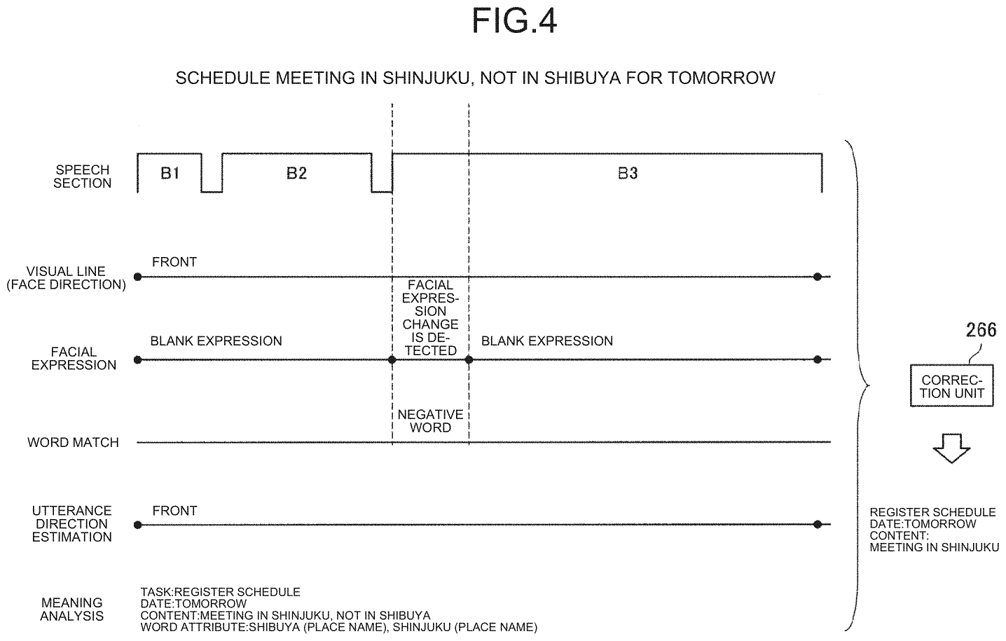

FIG. 4 is an explanatory diagram illustrating a second example of the meaning correction. FIG. 4 illustrates an example in which a user utters a speech “Schedule meeting in Shinjuku, not in Shibuya for tomorrow”. In this example, the speech section detection unit 242 detects a speech section B1 corresponding to a speech “for tomorrow”, a speech section B2 corresponding to a speech “in Shibuya”, and a speech section B3 corresponding to a speech “schedule meeting in Shinjuku, not” from one utterance section. The meaning analysis unit 262 analyzes the speech to acquire that the task is to register a schedule, the date is tomorrow, the content is “meeting in Shinjuku, not in Shibuya”, and the word attribute of Shibuya and Shinjuku is a place name.

Moreover, in the example of FIG. 4, the visual line identification unit 224 identifies that the visual line direction is front throughout the speech sections B1 to B3. The facial expression identification unit 226 detects a change in the facial expression in the speech section B3. The word detection unit 244 detects “not” falling under the negative word in the speech section B2. The utterance direction estimation unit 245 estimates that the utterance direction is front throughout the speech sections B1 to B3.

The correction unit 266 specifies whether each speech portion uttered by the user corresponds to the correct speech or the error speech based on the analysis results of the user behaviors such as the visual line direction, the facial expression and the utterance direction, and the detection of the negative word. In the example illustrated in FIG. 4, the correction unit 266 determines that the user corrects the place name during the utterance and specifies the speech portion corresponding to “not in Shibuya” as the error speech based on the facts that the negative word is detected in the speech section B3, the place names are placed before and after the negative word “not”, and the change in the facial expression is detected during the utterance of the negative word “not”.

As a result, the correction unit 266 deletes the meaning of the speech portion corresponding to “not in Shibuya” from the meaning of the uttered speech acquired by the meaning analysis unit 262. That is, the correction unit 266 corrects the content of the schedule from “meeting in Shinjuku, not in Shibuya” to “meeting in Shinjuku”. With such a configuration, the processing execution unit 280 registers “meeting in Shinjuku” as a schedule for tomorrow.

### Third Example

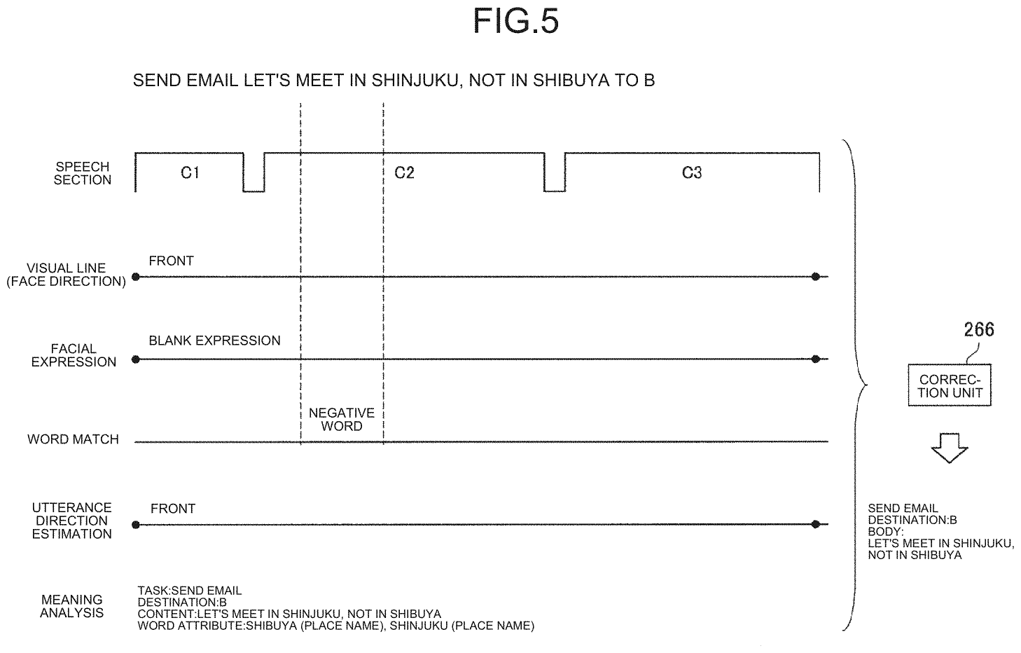

FIG. 5 is an explanatory diagram illustrating a third example of the meaning correction. FIG. 5 illustrates an example in which a user utters a speech “Send an email let's meet in Shinjuku, not in Shibuya to B”. In this example, the speech section detection unit 242 detects a speech section C1 corresponding to a speech “to B”, a speech section C2 corresponding to a speech “let's meet in Shinjuku, not in Shibuya”, and a speech section C3 corresponding to a speech “send an email” from one utterance section. The meaning analysis unit 262 analyzes the speech to acquire that the task is to send an email, the destination is B, the body is “let's meet in Shinjuku, not in Shibuya”, and the word attribute of Shibuya and Shinjuku is a place name.

Moreover, in the example of FIG. 5, the visual line identification unit 224 identifies that the visual line direction is front throughout the speech sections C1 to C3. The facial expression identification unit 226 detects that the facial expression is a blank expression throughout the speech sections C1 to C3. The word detection unit 244 detects “not” falling under the negative word in the speech section C2. The utterance direction estimation unit 245 estimates that the utterance direction is front throughout the speech sections C1 to C3.

The correction unit 266 specifies whether each speech portion uttered by the user corresponds to the correct speech or the error speech based on the analysis results of the user behaviors such as the visual line direction, the facial expression and the utterance direction, and the detection of the negative word. In the example illustrated in FIG. 5, the negative word “not” is detected in the speech section C2. However, no change is detected in the user behaviors such as the visual line, the facial expression and the utterance direction. Moreover, the storage unit 264 stores therein information indicating that a relation between B and the user is “friends”. The body of the email between friends may include the negative word in spoken language. The email body can also include the negative word. Based on the situation and circumstances, the correction unit 266 does not treat the negative word “not” in the speech section C2 as the error speech. That is, the correction unit 266 does not correct the meaning of the uttered speech acquired by the meaning analysis unit 262. As a result, the processing execution unit 280 sends an email having a body “Let's meet in Shinjuku, not in Shibuya” to B.

### Fourth Example

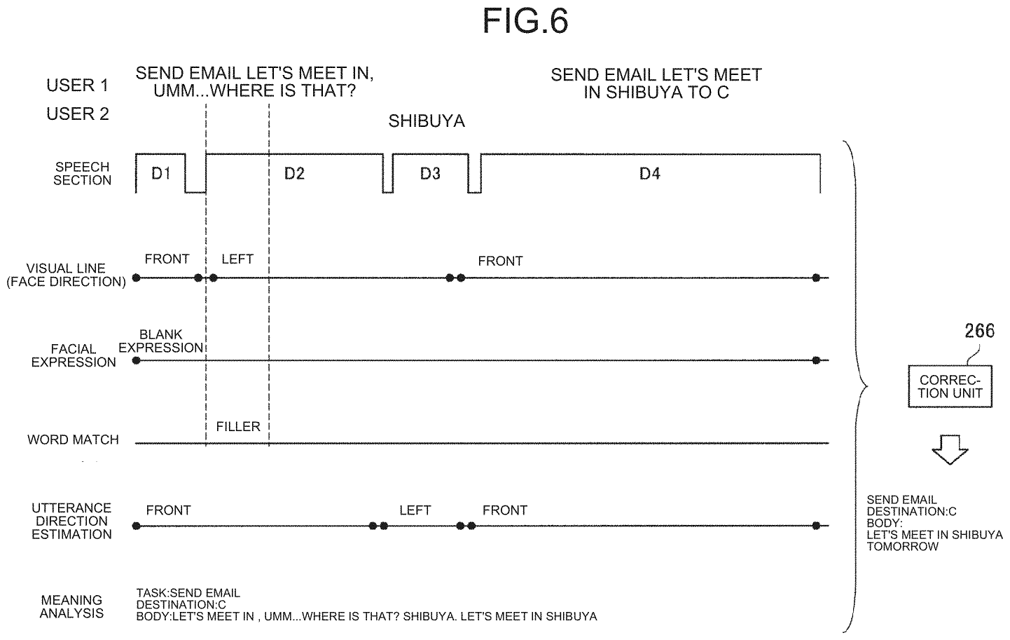

FIG. 6 is an explanatory diagram illustrating a fourth example of the meaning correction. FIG. 6 illustrates an example in which a user 1 utters a speech “Send an email let's meet in, umm . . . where is that”, a user 2 utters a speech “Shibuya”, and the user 1 utters a speech “Shibuya tomorrow to C”. In this example, the speech section detection unit 242 detects a speech section D1 corresponding to a speech “tomorrow”, a speech section D2 corresponding to a speech “umm . . . where is that?” a speech section D3 corresponding to a speech “Shibuya”, and a speech section D4 corresponding to a speech “send an email let's meet in Shibuya to C” from one utterance section. The meaning analysis unit 262 analyzes the speech to acquire that the task is to send an email, the destination is C, and the body is “let's meet in, umm . . . where is that? Shibuya. Shibuya tomorrow”.

Moreover, in the example of FIG. 6, the visual line identification unit 224 identifies that the visual line direction is front in the speech sections D1 and D4 and left throughout the speech sections D2 to D3. The facial expression identification unit 226 detects that the facial expression is a blank expression throughout the speech sections D1 to D4. The word detection unit 244 detects “umm” falling under the filler in the speech section D2. The utterance direction estimation unit 245 estimates that the utterance direction is front in the speech sections D1 to D2 and D4, and left in the speech section D3.

The correction unit 266 specifies whether each speech portion uttered by the user corresponds to the correct speech or the error speech based on the analysis results of the user behaviors such as the visual line direction, the facial expression and the utterance direction, and the detection of the filler. In the example illustrated in FIG. 6, the correction unit 266 specifies the speech portion corresponding to the speech section D2 as the error speech (a soliloquy or talking to another person) based on the facts that the filler “umm” is detected in the speech section D2, the visual line is changed to left in the speech section D2, and the speech section D2 is determined as a portion representing the email body.

Additionally, in the example illustrated in FIG. 6, the utterance direction is changed to left in the speech section D3. Thus, the speech in the speech section D3 is considered to be uttered by a different user from the user who has uttered the speech in the other speech sections. Consequently, the correction unit 266 specifies the speech portion corresponding to the speech section D3 as the error speech (uttered by another person).

As a result, the correction unit 266 deletes the meanings of the portions corresponding to the speech sections D2 and D3 from the meaning of the uttered speech acquired by the meaning analysis unit 262. That is, the correction unit 266 corrects the meaning of the email body from “let's meet in, umm . . . where is that? Shibuya. Shibuya tomorrow” to “let's meet in Shibuya tomorrow”. With such a configuration, the processing execution unit 280 sends an email having a body “Let's meet in Shibuya tomorrow” intended for conveyance by the user to C.

The example in which the speech uttered by a user other than the user who has uttered the speech to be processed by the speech processing apparatus 20 is also input to the meaning analysis unit 262 has been described above. Alternatively, the speech acquired to be uttered by another user based on the utterance direction estimated by the utterance direction estimation unit 245 may be deleted before input to the meaning analysis unit 262.

Operation of Speech Processing Apparatus

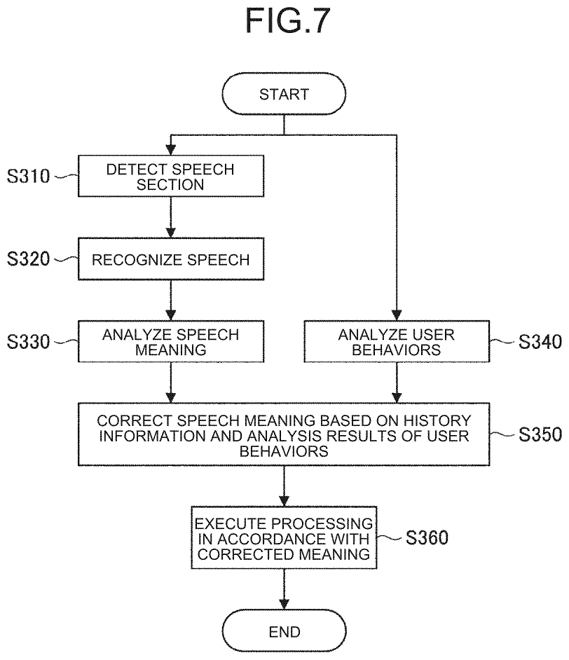

The configuration of the speech processing apparatus 20 and the specific examples of the processing according to the embodiment of the present disclosure have been described above. Subsequently, the operation of the speech processing apparatus 20 according to the embodiment of the present disclosure will be described with reference to FIG. 7.

FIG. 7 is a flowchart illustrating the operation of the speech processing apparatus 20 according to the embodiment of the present disclosure. As illustrated in FIG. 7, the speech section detection unit 242 of the speech processing apparatus 20 according to the embodiment of the present disclosure analyzes the sound signal input from the sound collection unit 241, and detects the speech section equivalent to the speech signal in the sound signal by using the intensity (amplitude) of the sound signal and the feature value indicating a speech likelihood (S310).

The speech recognition unit 243 recognizes the speech signal input from the speech section detection unit 242 to obtain the character string representing the speech uttered by the user (S320). The meaning analysis unit 262 then analyzes the meaning of the character string input from the speech recognition unit 243 (S330).

In parallel with the above steps at 5310 to 5330, the speech processing apparatus 20 analyzes the user behaviors (S340). For example, the visual line identification unit 224 of the speech processing apparatus 20 identifies the visual line direction of the user, and the facial expression identification unit 226 identifies the facial expression of the user.

After that, the correction unit 266 corrects the analysis results of the character string obtained by the meaning analysis unit 262 based on the history information stored in the storage unit 264 and the analysis results of the user behaviors (S350). The processing execution unit 280 executes the processing in accordance with the meaning corrected by the correction unit 266 (S360).

Modification

The embodiment of the present disclosure has been described above. Hereinafter, some modifications of the embodiment of the present disclosure will be described. Note that the respective modifications described below may be applied to the embodiment of the present disclosure individually or by combination. Additionally, the respective modifications may be applied instead of the configuration described in the embodiment of the present disclosure or added to the configuration described in the embodiment of the present disclosure.

For example, the function of the correction unit 266 may be enabled/disabled depending on an application to be used, that is, the task in accordance with the meaning analyzed by the meaning analysis unit 262. To be more specific, the error speech may be easily generated in some applications, and difficult to be generated in other applications. In this case, the function of the correction unit 266 is disabled in the application in which the error speech is difficult to be generated and is enabled in the application in which the error speech is easily generated. This allows prevention of correction not intended by the user.

Additionally, the above embodiment has described the example in which the correction unit 266 performs the meaning correction after the meaning analysis performed by the meaning analysis unit 262. The processing order and the processing contents are not limited to the above example. For example, the correction unit 266 may delete the error speech portion first, and the meaning analysis unit 262 may then analyze the meaning of the character string from which the error speech portion has been deleted. This configuration can shorten the length of the character string as a target of the meaning analysis performed by the meaning analysis unit 262, and reduce the processing load on the meaning analysis unit 262.

Moreover, the above embodiment has described the example in which the speech processing apparatus 20 has the plurality of functions illustrated in FIG. 2 implemented therein. Alternatively, the functions illustrated in FIG. 2 may be at least partially implemented in an external server. For example, the functions of the eye feature value extraction unit 223, the visual line identification unit 224, the face feature value extraction unit 225, the facial expression identification unit 226, the speech section detection unit 242, the speech recognition unit 243, the utterance direction estimation unit 245, the speech feature detection unit 246, and the emotion identification unit 247 may be implemented in a cloud server on the network. The function of the word detection unit 244 may be implemented not only in the speech processing apparatus 20 but also in the cloud server on the network. The analysis unit 260 may be also implemented in the cloud server. In this case, the cloud server functions as the speech processing apparatus.

Hardware Configuration

The embodiment of the present disclosure has been described above. The information processing such as the image processing, the speech processing and the meaning analysis described above is achieved by cooperation between software and hardware of the speech processing apparatus 20 described below.

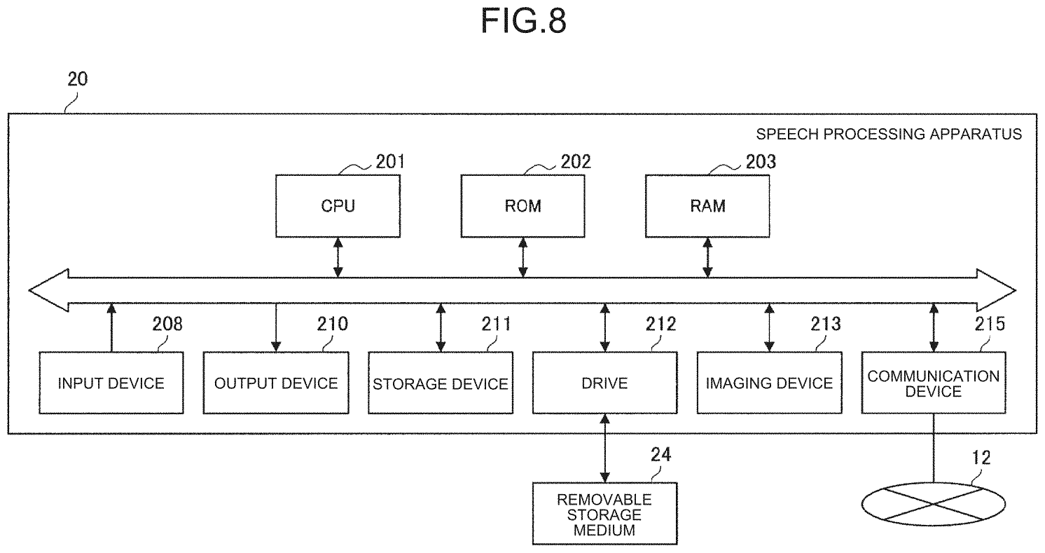

FIG. 8 is an explanatory diagram illustrating a hardware configuration of the speech processing apparatus 20. As illustrated in FIG. 8, the speech processing apparatus 20 includes a central processing unit (CPU) 201, a read only memory (ROM) 202, a random access memory (RAM) 203, an input device 208, an output device 210, a storage device 211, a drive 212, an imaging device 213, and a communication device 215.

The CPU 201 functions as an arithmetic processor and a controller and controls the entire operation of the speech processing apparatus 20 in accordance with various computer programs. The CPU 201 may be also a microprocessor. The ROM 202 stores computer programs, operation parameters or the like to be used by the CPU 201. The RAM 203 temporarily stores computer programs to be used in execution of the CPU 201, parameters that appropriately change in the execution, or the like. These units are connected mutually via a host bus including, for example, a CPU bus. The CPU 201, the ROM 202, and the RAM 203 can cooperate with software to achieve the functions of, for example, the eye feature value extraction unit 223, the visual line identification unit 224, the face feature value extraction unit 225, the facial expression identification unit 226, the speech section detection unit 242, the speech recognition unit 243, the word detection unit 244, the utterance direction estimation unit 245, the speech feature detection unit 246, the emotion identification unit 247, the analysis unit 260, and the processing execution unit 280 described with reference to FIG. 2.

The input device 208 includes an input unit that allows the user to input information, such as a mouse, a keyboard, a touch panel, a button, a microphone, a switch and a lever, and an input control circuit that generates an input signal based on the input from the user and outputs the input signal to the CPU 201. The user of the speech processing apparatus 20 can input various data or instruct processing operations to the speech processing apparatus 20 by operating the input device 208.

The output device 210 includes a display device such as a liquid crystal display (LCD) device, an organic light emitting diode (OLED) device, and a lamp. The output device 210 further includes a speech output device such as a speaker and a headphone. The display device displays, for example, a captured image or a generated image. Meanwhile, the speech output device converts speech data or the like to a speech and outputs the speech.

The storage device 211 is a data storage device configured as an example of the storage unit of the speech processing apparatus 20 according to the present embodiment. The storage device 211 may include a storage medium, a recording device that records data on the storage medium, a read-out device that reads out the data from the storage medium, and a deleting device that deletes the data recorded on the storage medium. The storage device 211 stores therein computer programs to be executed by the CPU 201 and various data.

The drive 212 is a storage medium reader-writer, and is incorporated in or externally connected to the speech processing apparatus 20. The drive 212 reads out information recorded on a removable storage medium 24 such as a magnetic disk, an optical disk, a magneto-optical disk or a semiconductor memory loaded thereinto, and outputs the information to the RAM 203. The drive 212 can also write information onto the removable storage medium 24.

The imaging device 213 includes an imaging optical system such as a photographic lens and a zoom lens for collecting light, and a signal conversion element such as a charge coupled device (CCD) or a complementary metal oxide semiconductor (CMOS). The imaging optical system collects light emitted from a subject to form a subject image on the signal conversion unit, and the signal conversion element converts the formed subject image to an electrical image signal.

The communication device 215 is, for example, a communication interface including a communication device to be connected to the network 12. The communication device 215 may be also a wireless local area network (LAN) compatible communication device, a long term evolution (LTE) compatible communication device, or a wired communication device that performs wired communication.

Conclusion

In accordance with the embodiment of the present disclosure described above, various effects can be obtained.

For example, the speech processing apparatus 20 according to the embodiment of the present disclosure specifies the portion corresponding to the correct speech and the portion corresponding to the error speech by using not only the detection of a particular word but also the user behaviors when the particular word is detected. Consequently, a more appropriate specification result can be obtained. The speech processing apparatus 20 according to the embodiment of the present disclosure can also specify the speech uttered by a different user from the user who has uttered the speech to the speech processing apparatus 20 as the error speech by further using the utterance direction.

The speech processing apparatus 20 according to the embodiment of the present disclosure deletes or corrects the meaning of the portion specified as the error speech. Thus, even when the speech of the user includes the error speech, the speech processing apparatus 20 can obtain the meaning intended for conveyance by the user from the speech of the user without requiring the user to utter the speech again. As a result, the trouble for the user can be reduced.

The preferred embodiment(s) of the present disclosure has/have been described in detail with reference to the accompanying drawings, whilst the technical scope of the present disclosure is not limited to the above examples. A person skilled in the art may find various alterations and modifications within the technical scope of the appended claims, and it should be understood that they will naturally come under the technical scope of the present disclosure.

For example, the respective steps in the processing carried out by the speech processing apparatus 20 in this specification do not necessarily have to be time-sequentially performed in accordance with the order described as the flowchart. For example, the respective steps in the processing carried out by the speech processing apparatus 20 may be performed in an order different from the order described as the flowchart, or may be performed in parallel.

Additionally, a computer program that allows the hardware such as the CPU, the ROM and the RAM incorporated in the speech processing apparatus 20 to demonstrate a function equivalent to that of each configuration of the speech processing apparatus 20 described above can also be created. A storage medium storing the computer program is also provided.

Moreover, the effects described in this specification are merely illustrative or exemplary, and not restrictive. That is, with or in the place of the above effects, the technology according to the present disclosure can achieve other effects that are obvious to a person skilled in the art from the description of this specification.

Additionally, the present technology may also be configured as below.

(1)

A speech processing apparatus comprising an analysis unit configured to analyze a meaning of speech uttered by a user based on a recognition result of the speech and an analysis result of a behavior of the user while the user is uttering the speech.

(2)

The speech processing apparatus according to (1), wherein the analysis unit includes

a meaning analysis unit configured to analyze the meaning of the speech uttered by the user based on the recognition result of the speech, and

a correction unit configured to correct the meaning obtained by the meaning analysis unit based on the analysis result of the behavior of the user.

(3)

The speech processing apparatus according to (2), wherein the correction unit determines whether to delete the meaning of the speech corresponding to one speech section in an utterance period of the user based on the analysis result of the behavior of the user in the speech section.

(4)

The speech processing apparatus according to any one of (1) to (3), wherein the analysis unit uses an analysis result of a change in a visual line of the user as the analysis result of the behavior of the user.

(5)

The speech processing apparatus according to any one of (1) to (4), wherein the analysis unit uses an analysis result of a change in a facial expression of the user as the analysis result of the behavior of the user.

(6)

The speech processing apparatus according to any one of (1) to (5), wherein the analysis unit uses an analysis result of a change in an utterance direction as the analysis result of the behavior of the user.

(7)

The speech processing apparatus according to any one of (1) to (6), wherein the analysis unit further analyzes the meaning of the speech based on a relation between the user and another user indicated by the speech.

(8)

The speech processing apparatus according to (3), wherein the correction unit further determines whether to delete the meaning of the speech corresponding to the speech section based on whether a particular word is included in the speech section.

(9)

The speech processing apparatus according to (8), wherein the particular word includes a filler or a negative word.

(10)

The speech processing apparatus according to any one of (1) to (9), further comprising:

a speech input unit to which the speech uttered by the user is input;

a speech recognition unit configured to recognize the speech input to the speech input unit;

a behavior analysis unit configured to analyze the behavior of the user while the user is uttering the speech; and

a processing execution unit configured to execute processing in accordance with the meaning obtained by the analysis unit.

(11)

A speech processing method comprising analyzing, by a processor, a meaning of speech uttered by a user based on a recognition result of the speech and an analysis result of a behavior of the user while the user is uttering the speech.

### REFERENCE SIGNS LIST

20 SPEECH PROCESSING APPARATUS

30 MOBILE TERMINAL

220 IMAGE PROCESSING UNIT

221 IMAGING UNIT

222 FACE IMAGE EXTRACTION UNIT

223 EYE FEATURE VALUE EXTRACTION UNIT

224 VISUAL LINE IDENTIFICATION UNIT

225 FACE FEATURE VALUE EXTRACTION UNIT

226 FACIAL EXPRESSION IDENTIFICATION UNIT

240 SPEECH PROCESSING UNIT

241 SOUND COLLECTION UNIT

242 SPEECH SECTION DETECTION UNIT

243 SPEECH RECOGNITION UNIT

244 WORD DETECTION UNIT

245 UTTERANCE DIRECTION ESTIMATION UNIT

246 SPEECH FEATURE DETECTION UNIT

247 EMOTION IDENTIFICATION UNIT

260 ANALYSIS UNIT

262 MEANING ANALYSIS UNIT

264 STORAGE UNIT

266 CORRECTION UNIT

280 PROCESSING EXECUTION UNIT

1. A speech processing apparatus comprising an analysis unit configured to analyze a meaning of speech uttered by a user based on a recognition result of the speech and an analysis result of a behavior of the user while the user is uttering the speech.

2. The speech processing apparatus according to claim 1, wherein the analysis unit includes
a meaning analysis unit configured to analyze the meaning of the speech uttered by the user based on the recognition result of the speech, and
a correction unit configured to correct the meaning obtained by the meaning analysis unit based on the analysis result of the behavior of the user.

3. The speech processing apparatus according to claim 2, wherein the correction unit determines whether to delete the meaning of the speech corresponding to one speech section in an utterance period of the user based on the analysis result of the behavior of the user in the speech section.

4. The speech processing apparatus according to claim 1, wherein the analysis unit uses an analysis result of a change in a visual line of the user as the analysis result of the behavior of the user.

5. The speech processing apparatus according to claim 1, wherein the analysis unit uses an analysis result of a change in a facial expression of the user as the analysis result of the behavior of the user.

6. The speech processing apparatus according to claim 1, wherein the analysis unit uses an analysis result of a change in an utterance direction as the analysis result of the behavior of the user.

7. The speech processing apparatus according to claim 1, wherein the analysis unit further analyzes the meaning of the speech based on a relation between the user and another user indicated by the speech.

8. The speech processing apparatus according to claim 3, wherein the correction unit further determines whether to delete the meaning of the speech corresponding to the speech section based on whether a particular word is included in the speech section.

9. The speech processing apparatus according to claim 8, wherein the particular word includes a filler or a negative word.

10. The speech processing apparatus according to claim 1, further comprising:
a speech input unit to which the speech uttered by the user is input;
a speech recognition unit configured to recognize the speech input to the speech input unit;
a behavior analysis unit configured to analyze the behavior of the user while the user is uttering the speech; and
a processing execution unit configured to execute processing in accordance with the meaning obtained by the analysis unit.

11. A speech processing method comprising analyzing, by a processor, a meaning of speech uttered by a user based on a recognition result of the speech and an analysis result of a behavior of the user while the user is uttering the speech.
